(19) United States
(12) Patent Application Publication
(10) Pub. No.: US 2023/0255738 A1
(43) Pub. Date: Aug. 17, 2023

(54) APPARATUS AND METHOD FOR THE AUTOMATED TRANSPORT OF LIVE BIRDS

(71) Applicant: BIG DUTCHMAN INTERNATIONAL GMBH, Vechta (DE)

(72) Inventors: Günter Möller, Essen (DE); Ludger Timmer, Löningen OT Benstrup (DE)

(73) Assignee: BIG DUTCHMAN INTERNATIONAL GMBH, Vechta (DE)

(21) Appl. No.: 18/022,546

(22) PCT Filed: Jul. 29, 2021
(86) PCT No.: PCT/EP2021/071275

§ 371 Date: Feb. 22, 2023

(30) Foreign Application Priority Data
Aug. 26, 2020 (LU) LU102012

(51) Int. Cl. A61D 3/00; A01K 37/00; A61D 1/02

(52) U.S. Cl. CPC A61D 3/00; A01K 37/00; A61D 1/025

(57) ABSTRACT

A transport device for automatically transporting living poultry animals in a transport direction is disclosed, along with a method for automatically transporting living poultry animals in a transport direction, a method for commencing the operation of a transport device, and a method for automatically performing a handling operation on living poultry animals, and to the use of a transport device. The transport device comprises a transport rail which extends along a transport axis and which has two guide elements and a transport receptacle formed between said guide elements, at least one driver device which has two holding elements, wherein each holding element has a driver portion and a receiving recess, and a drive which is configured to move the at least one driver device along the transport rail.

### CROSS-REFERENCE TO FOREIGN PRIORITY APPLICATION

The present application claims the benefit under 35 U.S.C. §§ 119(b), 119(e), 120, and/or 365(c) of PCT/EP2021/071275 filed Jul. 29, 2021, which claims priority to Application No. LU102012 filed Aug. 26, 2020.

### FIELD OF THE INVENTION

The invention relates to a transport device for automatically transporting living poultry animals in a transport direction, and to a method for automatically transporting living poultry animals in a transport direction, a method for commencing the operation of a transport device, and a method for automatically performing a handling operation on living poultry animals, and to the use of a transport device.

### BACKGROUND OF THE INVENTION

Devices and methods for automatically transporting living poultry animals (and optionally for performing further handling operations) are known for example from WO 2017/125387 A1, WO 2015/077432 A2, FR 2885030 A1, US 10,350,041 B2 or WO 2017/125394 A1.

Existing solutions however have various disadvantages. For example, in existing solutions, the poultry animals are often brought into a constrained posture that is often inconsistent with a natural posture of the poultry animals, for example, into an upside-down position. Furthermore, the poultry animals tend to have the propensity to free themselves from, or to not want to assume, a constrained posture. This leads to agitation, tension, and stress in the poultry animals, and furthermore poses a risk of injury to the poultry animals. This furthermore has the effect that certain manipulating operations and/or handling operations cannot be performed, or can be performed only inadequately, on the poultry animals. A high level of normally personnel-intensive effort is also required to bring the poultry animals into the corresponding constrained posture.

Existing systems in which the poultry animals have more freedom of movement, and are transported for example in a suspended position, however, have the disadvantage that the poultry animals are not in a clearly defined position. It is therefore also the case here that certain manipulating operations and/or handling operations cannot be performed or can be performed only inadequately, in particular if a defined position and/or an in particular defined resistance is required for this purpose.

It is, therefore, an object of the present invention to specify a transport device and a method for automatically transporting living poultry animals in a transport direction, a method for commencing the operation of a transport device, a method for automatically performing a handling operation on living poultry animals, and the use of a transport device, which alleviate one or more of the stated disadvantages. In particular, it is an object of the present invention to provide a transport device and a method for automatically transporting living poultry animals in a transport direction, a method for commencing the operation of a transport device, a method for automatically performing a handling operation on living poultry animals, and the use of a transport device, which improve animal welfare and/or allow improved manipulation and/or allow handling operations on the poultry animals to be performed in an improved manner.

Said object is achieved according to a first aspect by a transport device for automatically transporting living poultry animals in a transport direction, comprising a transport rail which extends along a transport axis and which has two guide elements and a transport receptacle formed between said guide elements, at least one driver device which has two holding elements, wherein each holding element has a driver portion and a receiving recess, and a drive which is configured to move the at least one driver device along the transport rail.

The transport device serves for automatically transporting living poultry animals. Automatic transport is to be understood, in particular, to mean transport that is implemented substantially without the poultry animals being manually manipulated by persons. This relates in particular to the transport within and through the transport device. Manual manipulation steps may be performed by personnel when the poultry animals are introduced into the transport device and/or when the poultry animals are discharged from the transport device.

The transport takes place along a transport direction, which may preferably extend from a first end to a second end of the transport device. The transport device is in particular configured to transport living poultry animals within a poultry house, for example from a first position within the poultry house to a second position within the same poultry house.

The transport device has at least one transport rail which has two guide elements and a transport receptacle formed between said guide elements. The transport rail extends along a transport axis. The transport axis may be a straight line, though may also describe a path which is not straight and which, for example, has curves, bends, and/or changes in direction. The transport axis is preferably situated centrally between those ends of the guide elements which are the upper ends in the operating state. The transport direction preferably runs parallel to the transport axis. The vertical plane that encompasses the transport axis may, like the transport axis, be a planar plane or a non-planar plane which has for example curves, bends and/or changes in direction in particular in directions that deviate from the vertical.

In one preferred refinement of the transport device, said transport device has two or more preferably parallel transport rails. Provision may furthermore be made for the transport device to have two or more transport rails that may preferably be identical. The provision of two or more transport rails can increase the capacity of the transport device and thus contribute to a particularly efficient solution. If two or more transport rails are provided, it is preferably also possible for individual, several, or all further components of the transport device that are described here, such as fixing device, driver device, weighing device, functional devices, placement device, inspection device, and/or needle arrangement, to also be correspondingly provided in numbers of two or more. Furthermore, it may also be preferable for individual, several, or all further components of the transport device that are described here, such as the drive, to be provided only singly, and to be used to operate two transport rails.

The two guide elements of the transport rail, in particular the upper ends thereof, are preferably spaced apart from one another. The guide elements preferably likewise extend parallel to the transport axis. The transport receptacle is formed between the two guide elements. The two guide elements may be connected to another and/or transition into one another at their lower ends, wherein the connection of the two lower ends of the guide elements may for example simultaneously form the lower end of the transport receptacle. The transport receptacle can thus preferably be understood as the free space between the two guide elements. The transport rail may for example assume the form of a groove. As will be discussed in more detail below, the transport receptacle serves in particular for receiving the breastbone and/or sternum of a poultry animal, wherein the poultry animal in particular assumes a position in which its thoracic spine, in particular, the region between the shoulder joint and the hip joint, is oriented substantially horizontally.

The transport device furthermore has a driver device with two holding elements. Each of the holding elements has a driver portion and a receiving recess. The transport device furthermore has a drive that is configured to move the at least one driver device along the transport rail.

The transport device furthermore has at least one driver device that can be moved along the transport rail by means of the drive. A relative movement thus takes place between the driver device and the transport rail. The driver device is movable along and relative to the transport rail. The transport rail is thus preferably in a fixed position relative to the driver device. Where the description below states that the transport device is configured to be mobile, the transport rail as part of the transport device is also mobile. In the operational state of the transport device, in particular during the operation of the transport device for the purposes of automatically transporting poultry animals, the transport rail is however preferably in a fixed position, in particular relative to the at least one driver device and/or the poultry animals that are to be transported.

The driver device serves, as it moves along the transport rail, to drive a poultry animal along. The driver device can thus, in particular, cause the poultry animal to also be moved along the transport rail. For this purpose, the driver device has two holding elements. The two holding elements are preferably spaced apart from one another. Each of the holding elements has a driver portion and a receiving recess. As will be described in more detail below, the receiving recess is, in particular, configured to receive a part of the poultry animal, in particular, its scapulohumeral joint and/or shoulder joint. The driver portion serves in particular for driving the poultry animal along, in particular by abutting against that part of the poultry animal which is arranged in the receiving recess, as the driver device moves.

The solution described here is based inter alia on the findings described below, and has inter alia the advantages described below.

The transport of living poultry animals involves particular requirements. By contrast to transport devices that are intended for dead poultry animals, it is necessary in the case of transport devices for living poultry animals to take into consideration their need for movement and aversion to unnatural constrained postures. Living poultry animals furthermore have mostly intact plumage. The plumage of living poultry animals exhibits lower static friction than the skin of dead poultry animals, the plumage of which has already been removed. In this way, living poultry animals can slide along on a transport rail that has or is composed for example of metal, in particular high-grade steel, whereas this is not possible, or is possible only to a significantly diminished degree, with dead poultry animals of which the plumage has already been removed.

The solution described here has the advantage inter alia that, with the transport rail, a means for supporting the poultry animals is created, in the case of which a part of the poultry animal, in particular the breastbone and/or the sternum, can come to lie in the transport receptacle between the guide elements. The poultry animal can then, in this position, be moved along the transport rail in the transport direction by means of the driver device. In this way, the poultry animal can slide along the transport rail, which is made easier or possible in particular by the plumage of the living poultry animals. It can thus be achieved that the poultry animals are transported in a gentle manner, because sliding along the transport rail is much more pleasant and less stressful for the poultry animals than an unnatural constrained posture.

The transport device described here has various further advantages over existing transport devices, in particular also with regard to any vaccinations that are to be performed in the transport device. In particular, existing devices for vaccination normally require high expenditure on personnel. The personnel must furthermore be trained and practiced in ensuring that, for example, an entire poultry animal population is correctly and reliably vaccinated. This is at the same time often carried out under great time pressure. This often comes at the expense of reliability and precision, with the result that such personnel-intensive vaccination is not only expensive but also susceptible to errors, and is therefore not adequately reliable. Furthermore, a personnel-intensive vaccination process also poses a greater risk because the personnel—who normally work in different houses in succession—can themselves also be a vector for the transmission of pathogens.

With the transport device described here and in more detail below, it is possible to vaccinate poultry animals using different vaccination devices in one pass through the transport device. The use of personnel, in particular for placing the poultry animals on and optionally for releasing the poultry animals, is considerably reduced here in relation to existing solutions. The vaccinations are preferably all carried out in automated fashion without the need for intervention by personnel for this purpose. In particular, and as will also be described in more detail below, it is preferable for a pox vaccination to be provided by administering the vaccine into the thigh, preferably into the inner side of the thigh, of the poultry animal, such that the administration of pox vaccine into the wing web, which is more personnel-intensive and less reliable, can be dispensed with. These automatic vaccinations are more reliable and precise not only because fewer manual steps are required during the vaccination process but also because, in the transport device described here, the poultry animals assume a relatively relaxed transport position and therefore behave relatively calmly, thus allowing considerably greater precision during the vaccination process.

Further findings and advantages will, in particular, also be described below with reference to the various embodiments.

### SUMMARY OF THE INVENTION

In one preferred embodiment, the transport device comprises a fixing device. The fixing device serves in particular for preventing poultry animals from leaving the transport device, in particular the transport rail, of their own accord. The fixing device is preferably configured so as not to make contact with the poultry animal, or at least so as not to exert pressure on the poultry animal, when the poultry animal is in the intended position on the transport rail. This position can also be referred to as transport position. Further details and advantages of the fixing device will be described in more detail below.

It is furthermore preferred that the transport device comprises a placement device which is positioned upstream of the transport rail in a transport direction and which preferably transitions into the transport rail. The placement device is used in particular for introducing poultry animals into the transport device. The placement device is preferably configured to make it easier for, and/or to cause, a poultry animal to be positioned in the intended position on the transport rail. Poultry animals may be placed onto the placement device of the transport device manually by personnel, for example, by virtue of persons picking up poultry animals and placing them onto the placement device. Further details and advantages of the placement device will be described in more detail below.

In one preferred embodiment, the transport device comprises multiple driver devices. This has the advantage that several poultry animals can be transported in the transport device, which in particular increases throughput and is an efficient solution. The driver devices are preferably identical. It is furthermore preferred that the driver devices are spaced apart from one another, preferably spaced apart from one another equidistantly, in a transport direction. In particular, it is preferred that the driver devices are spaced apart from one another by at least 150 mm or by at least 180 mm in a transport direction. It is furthermore preferred that the driver devices are spaced apart from one another by at most 530 mm or by at most 650 mm in a transport direction. The spacing of adjacent driver devices is preferably measured from a defined point of the respective driver device to the same defined point of the adjacent driver device, for example, from the receiving recess of a holding element of a first driver device to the receiving recess of a holding element of the adjacent driver device. A clear spacing between adjacent driver devices, that is to say in particular a spacing from a foremost point of a driver device as viewed in a transport direction to the rearmost point of the adjacent driver device as viewed in a transport direction, corresponds in particular at least to the length of a poultry animal, which is to be transported, in its intended position on the transport rail. The clear spacing between adjacent driver devices in a transport direction is preferably at least 150 mm. Further details and advantages of the driver devices will be described in more detail below.

In one preferred refinement, the transport device furthermore comprises a control device. The control device serves in particular for controlling individual, several or all components of the transport devices. Further details and advantages of the control device will be described in more detail below.

A further preferred refinement is distinguished by the fact that the transport device has two or more portions.

In one preferred embodiment, the transport device has at least one placement portion. The placement portion is used in particular for introducing poultry animals into the transport device.

The transport device preferably has at least one functional portion, preferably two or more functional portions. A functional portion is used in particular for performing a particular manipulating operation and/or handling operation in said portion. Further details and advantages of the functional portions will be described in more detail below.

The transport device furthermore preferably has at least one fixing portion. The fixing portion is in particular a portion in which the poultry animal is fixed by the fixing device.

The transport device furthermore preferably has at least one inspection portion. The inspection portion is used in particular for inspecting the poultry animal, for example with regard to particular characteristics and/or conditions and/or with regard to the result of previously performed handling operations.

The transport device furthermore preferably has at least one release portion. The release portion is used in particular for releasing the poultry animal again and discharging it from the transport device.

The various portions may also entirely or partially overlap. For example, the fixing portion may be configured to overlap with one, two, or more functional portions and/or the inspection portion and/or the release portion. For example, the inspection portion may be configured to overlap with one, two, or more functional portions and/or the release portion. For example, the placement portion may be configured to overlap with one, two, or more functional portions. For example, two, or more functional portions may be configured to overlap with one another.

Further details and advantages of the fixing portion, of the inspection portion and of the release portion will be described in more detail below.

In one preferred embodiment, the transport rail has, in a plane orthogonal to the transport axis, a cross section with a substantially M-shaped profile.

It is furthermore preferred that the transport rail is configured entirely or partially, in particular in certain portions, as a closed profile, and/or that the transport rail is configured entirely or partially, in particular in certain portions, as an open profile. The closed profile configuration is easy to clean and can make it easier for the poultry animals to be driven/slide along the transport rail. The closed profile configuration is preferred in particular in portions in which access is not required to those parts of the poultry animal which are situated in the transport receptacle. In the configuration as an open profile, the transport rail and/or the guide elements may for example have or consist of guide rods, gratings, and/or other structures with regular or irregular openings. The configuration as an open profile has the advantage that those parts of the poultry animal which are situated in the transport receptacle are also accessible, for example for manipulating operations, handling operations, and/or inspections.

A further preferred development is distinguished by the fact that the transport rail is configured such that the thoracic spine of a poultry animal that has been placed onto the transport rail, in particular in the region between the shoulder joint and the hip joint, is oriented substantially parallel to the transport axis and/or transport direction. This position preferably corresponds to the intended position of the poultry animal on the transport rail, and is a position that is relatively natural and/or pleasant for the poultry animal, in particular in relation to upside-down constrained postures.

Provision is preferably furthermore made for the transport rail to be configured such that the torso and/or the breast and/or the breastbone and/or the sternum of a poultry animal that has been placed onto the transport rail is or are arranged in the transport receptacle. The torso and/or the breast and/or the breastbone and/or the sternum of a poultry animal that has been placed onto the transport rail are preferably held in the transport receptacle. The transport receptacle may preferably have a shape which is adapted to the torso and/or the breast and/or the breastbone and/or the sternum of a poultry animal and/or which provides a suitable seat, which is pleasant for the poultry animal, in the transport receptacle.

In one preferred embodiment, provision is made for the transport rail to be configured such that the hip joints and/or the shoulder joints and/or the scapulohumeral joints of a poultry animal that has been placed onto the transport rail are arranged at an upper end of the transport rail and/or project above the transport rail. In this way, the legs and/or wings of the poultry animal can project laterally beyond the guide elements, such that only the torso and/or the breast and/or the breastbone and/or the sternum of a poultry animal that has been placed onto the transport rail is or are arranged in the transport receptacle, but the legs and/or wings of the poultry animal are not. A height of the guide elements from their lower end to their upper end, which preferably also corresponds to the height of the transport receptacle, is preferably dimensioned so as to correspond to the extent of the torso and/or of the breast and/or of the breastbone and/or of the sternum of a poultry animal. The height of the guide elements and/or of the transport receptacle is preferably at least 40 mm and/or at most 80 mm, in particular approximately 60 mm.

Furthermore, it is preferable in particular for the transport rail to be configured such that the wings and/or the legs of a poultry animal that has been placed onto the transport rail project outward beyond the guide elements. This has the advantage that, despite the natural and relaxed position of the poultry animals, their freedom of movement is at least partially restricted, and a defined and substantially constant position of the poultry animals during transport is thus achieved. Furthermore, in this way, the wings and/or legs of the poultry animal are situated outside the transport receptacle and are thus accessible for manipulating operations and/or handling operations.

The above-described details and possible refinements of the transport rail each individually, but also in their possible combinations, have the advantage that the poultry animal can be brought into a defined and at the same time relaxed position. In this way, the poultry animals can be transported with low stress, and can at the same time be reliably manipulated and/or handled. The risk of injury and the risk of inadequate handling as a result of the poultry animals being agitated and attempting to escape is reduced.

It is furthermore preferred that the guide elements are configured as guide rods, for example, as round tubes, and/or as support webs.

In one preferred embodiment, provision is made for the guide elements to each have the same spacing to the transport axis and/or to a vertical plane that encompasses the transport axis, in particular orthogonally with respect to the transport axis and/or with respect to a vertical plane that encompasses the transport axis. Said spacing is preferably adjustable, preferably by means of a guide element adjusting device.

A preferred refinement is distinguished by the fact that the guide elements each have an upper vertex, wherein the upper vertex preferably has a radius of at least 2.5 mm and/or at most 15 mm.

In one preferred embodiment, provision is made for the guide elements, which are configured as support webs, to each have an inner flank directed toward the transport receptacle. The inner flank preferably encloses an angle of at least 19° and/or at most 55° with respect to the vertical, which in particular passes through the vertex, and/or with respect to a vertical plane that encompasses the transport axis.

Furthermore, provision is preferably made for the guide elements, which are configured as support webs, to each have an outer flank directed away from the transport receptacle. The outer flank preferably encloses an angle of at least 50° and/or at most 70° with respect to the vertical, which in particular passes through the vertex, and/or with respect to a vertical plane that encompasses the transport axis. The inner flank and outer flank preferably enclose an angle of at least 100° and/or at most 140° with one another.

The inner flanks of the support webs may, in particular at least in certain portions, be of straight form and/or in particular concavely and/or convexly domed.

A further preferred development is distinguished by the fact that the guide elements are exchangeable. An adaptation to poultry animals with different characteristics, in particular with regard to body size and condition, is thus possible.

In a further preferred development, the guide elements are configured to be movable and/or flexible. In this way, a poultry animal with characteristics that differ for example from other poultry animals, in particular with regard to body size and condition, can be protected against injuries.

In one preferred embodiment, provision is made for the transport receptacle to have, in a plane orthogonal to the transport axis, a cross section with a V-shaped profile and/or a U-shaped profile. Provision is preferably furthermore made for the transport receptacle to be configured to receive a part of the poultry animal, in particular the torso and/or the breast and/or the breastbone and/or the sternum.

In a further preferred embodiment, provision is made for the transport receptacle to taper from its upper end toward its lower end, and/or for the transport receptacle to taper from an upper width toward a lower width and furthermore preferably toward its lower end, wherein the upper width is preferably greater than the lower width. The upper width is preferably at least 80 mm and/or at most 110 mm or at most 140 mm. The lower width is preferably at least 25 mm and/or at most 45 mm. The taper may be uniform, in particular at least in certain portions. The taper may also be stepped and/or vary in stepped fashion.

A further preferred development is distinguished by the fact that the respective receiving recess of the holding elements of the driver device is configured to receive a scapulohumeral joint and/or a shoulder joint of a poultry animal. Provision is preferably furthermore made for the respective driver portion of the holding elements to be configured to drive a scapulohumeral joint and/or a shoulder joint, which is arranged in the receiving recess, of a poultry animal in the transport direction. Preferably, the respective driver portion of the holding elements of the driver device is of hook-shaped configuration, such that the poultry animal, in particular the scapulohumeral joint and/or shoulder joint thereof, can be introduced into the receiving recess from above, and the driver portion engages behind the scapulohumeral joint and/or shoulder joint. When the drive moves the driver device along the transport rail, the driver portions pull the scapulohumeral joints and/or shoulder joints that are arranged in the receiving recesses, and thus the poultry animal as a whole, concomitantly along the transport rail.

In one preferred embodiment, provision is made for the driver device to have a holding position and a release position. The driver device is preferably pivotable from the holding position into the release position and vice versa, in particular about a pivot axis. The pivot axis is preferably arranged horizontally and/or orthogonally with respect to the transport axis and/or with respect to the transport direction.

The driver device is preferably secured against pivoting about an axis that is parallel to the transport axis. It can thus be ensured that the poultry animals are positioned and/or driven along by the driver device in a stable manner.

It is preferable for the driver device, in the holding position, to be arranged at least substantially above the transport rail, in particular above the upper ends of the guide elements. In particular, the holding elements, in particular the respective receiving recess and/or the respective driver portion, are, in the holding position, preferably arranged above the transport rail, in particular above the upper ends of the guide elements. In this way, when the poultry animals are placed on, the scapulohumeral joints and/or shoulder joints thereof can be easily inserted into the receiving recesses of the holding elements.

It is furthermore preferred that, in the holding position, a lower end of the respective receiving recess is arranged below the fixing device. It is furthermore preferred that, in the holding position, an upper end of the respective receiving recess and/or an upper end of the respective driver portion and/or an upper end of the respective holding element is arranged above the fixing device. It can thus be ensured, as will also be described in more detail below in conjunction with the fixing device, that a poultry animal cannot move its scapulohumeral joint and/or shoulder joint arranged in the receiving recess out of the receiving recess of their own accord, because the fixing device prevents a movement of the scapulohumeral joint and/or shoulder joint out of the receiving recess in an upward direction. This has the advantage that the poultry animals are prevented from freeing themselves from the intended transport position of their own accord.

The driver device is preferably in the holding position in the one or more functional portions and/or in the inspection portion. This has the advantage that the poultry animals can be reliably transported by the driver device in these portions.

It is preferable for the driver device, in the release position, to be arranged at least in certain portions below the upper ends of the guide elements. In particular, the holding elements, in particular the respective receiving recess and/or the respective driver portion, are, in the release position, preferably arranged below the upper ends of the guide elements.

In one preferred embodiment, provision is made for the driver device to be in the release position when in the release portion. In this way, the poultry animals are released in order that they can leave the transport device in the release portion of their own accord and/or in an assisted, optionally also manually assisted, manner.

In one preferred embodiment, provision is made for the holding elements to each have the same spacing to the transport axis and/or to a vertical plane that encompasses the transport axis. The spacing of the holding elements preferably substantially corresponds to the spacing between the scapulohumeral joints and/or the shoulder joints of the poultry animal. It is furthermore preferred that a spacing of the holding elements to the transport axis and/or to a vertical plane that encompasses the transport axis substantially corresponds to the spacing of the guide elements, in particular of the upper vertices of the guide elements, to the transport axis and/or to a vertical plane that encompasses the transport axis. A spacing of the holding elements to the transport axis and/or to a vertical plane that encompasses the transport axis is preferably adjustable, preferably by means of a holding element adjusting device. It is furthermore preferred that a spacing of the holding elements to the transport rail and/or to the transport axis is adjustable, preferably by means of a or the holding element adjusting device. Here, it is preferred in particular that the spacing of the fixing elements to one another and/or the spacing of the fixing elements to the transport axis and/or to a vertical plane that encompasses the transport axis, and/or the spacing of the fixing elements to the transport rail and/or to the transport axis, is symmetrically adjustable, preferably by means of a or the holding element adjusting device.

It is furthermore preferred that the driver device has a front pushing piece. The front pushing piece of a following driver device can, in particular when the driver device situated in front is already in the release position and can no longer drive the poultry animal along, exert a pressure in the transport direction on the poultry animal situated in front of the following driver device, in order to motivate or assist the poultry animal in leaving the transport device, in particular in the release portion.

In one preferred embodiment, provision is made for the fixing device to have two fixing elements. The fixing elements serve in particular to form a lateral guide for the neck and/or head of a poultry animal and/or to receive the neck and/or head of a poultry animal between them. As already mentioned, the fixing device is preferably configured so as not to make contact with the poultry animal, in particular the neck and/or head thereof, or at least so as not to exert pressure on the poultry animal, when the poultry animal is in the intended position on the transport rail. However, should the poultry animal attempt to move away from the transport rail, it would be prevented from doing so by the fixing device. That is to say, if the poultry animal actively moves, in particular in the direction of the fixing device, it makes contact with the fixing device, and the fixing device imparts a corresponding resistance to the movement of the poultry animal. By contrast, if the poultry animal remains in the intended natural and relaxed position on the transport rail, the poultry animal is also not constrained, or is constrained only very slightly.

It is preferred here, in particular, that the fixing device, in particular the two fixing elements, is arranged above the transport rail and/or above the lower ends of the respective receiving recesses and/or parallel to the transport axis. As has also been described above, it can thus be ensured that a poultry animal cannot move its scapulohumeral joint and/or shoulder joint arranged in the receiving recess out of the receiving recess of their own accord, because the fixing device prevents a movement of the scapulohumeral joint and/or shoulder joint out of the receiving recess in an upward direction.

The fixing device is preferably spaced apart from the transport rail, in particular in a vertical direction. In particular, the two fixing elements are preferably spaced apart from the transport rail, in particular in a vertical direction. The fixing device, in particular the two fixing elements, is or are preferably arranged in the functional portion(s) and/or in the inspection portion below an upper end of the driver device, in particular below an upper end of the respective holding element and/or the respective receiving recess and/or the respective holding portion. The fixing elements are preferably configured as rods, for example, as round tubes. In one preferred refinement, the fixing elements are formed from bent sheet-metal semifinished product, and have for example a radius transversely with respect to the longitudinal extent direction, giving rise to a vertex that points toward the poultry animal.

In one preferred embodiment, provision is made for the fixing elements to each have the same, in particular orthogonal, spacing to the transport axis and/or to a vertical plane that encompasses the transport axis.

It is furthermore preferred that the spacing of the fixing elements substantially corresponds to, or is greater than, the width of the neck of the poultry animal or of the head of the poultry animal or of the torso of the poultry animal. The spacing of the fixing elements to one another is preferably at least 50 mm. The spacing of the fixing elements is preferably substantially equal to or less than a width of the torso of the poultry animal. The spacing of the fixing elements to one another is preferably at most 80 mm. In particular, a spacing of the fixing elements is preferred which lies between a width of the neck of the poultry animal and a width of the torso of the poultry animal.

Preferably, a spacing of the fixing elements to the transport axis and/or to a vertical plane that encompasses the transport axis is less than a spacing of the guide elements, in particular of the upper vertices of the guide elements, to the transport axis and/or to a vertical plane that encompasses the transport axis.

Preferably, a spacing of the fixing elements to the transport axis and/or to a vertical plane that encompasses the transport axis is less than a spacing of the holding elements, in particular of the driver portions of the holding elements, to the transport axis and/or to a vertical plane that encompasses the transport axis.

It is furthermore preferred that the spacing of the fixing elements to the transport axis and/or to a vertical plane that encompasses the transport axis is adjustable in particular in a horizontal direction, preferably by means of a fixing element adjusting device. It is furthermore preferred that a spacing of the fixing elements to the transport rail and/or to the transport axis is adjustable, in particular in a vertical direction, preferably by means of a or the fixing element adjusting device. An adaptation to poultry animals with different characteristics, in particular with regard to body size and condition, is thus possible. Here, it is preferred in particular that the spacing of the fixing elements to one another and/or the spacing of the fixing elements to the transport axis and/or to a vertical plane that encompasses the transport axis, and/or the spacing of the fixing elements to the transport rail and/or to the transport axis, is symmetrically adjustable, and/or that the fixing element adjusting device is configured to symmetrically adjust the spacing of the fixing elements to one another and/or the spacing of the fixing elements to the transport axis and/or to a vertical plane that encompasses the transport axis, and/or the spacing of the fixing elements to the transport rail and/or to the transport axis.

In a preferred embodiment, provision is made for the fixing elements to each have a radius of at least 3 mm and/or at most 8 mm. It is furthermore preferred that the fixing elements each have a lower and/or inner vertex, wherein the lower and/or the upper vertex preferably has a radius of at least 3 mm and/or at most 8 mm.

A further preferred refinement is distinguished by the fact that the fixing device extends across one, two, several, or all portions of the transport device. In particular, the fixing device extends across the entire fixing portion.

In one preferred embodiment, provision is made for the fixing device, in particular the two fixing elements, to end, in the release portion, before an end of the transport rail, in particular before an end of the guide elements. It is preferred that the fixing device, in particular the two fixing elements, end(s) at least 20 mm before the end of the transport rail, in particular before the end of the guide elements. It is furthermore preferred that the fixing device, in particular the two fixing elements, end(s) at most 80 mm before the end of the transport rail, in particular before the end of the guide elements. This can make it easier for the poultry animals to be released in the release portion.

In one preferred embodiment, provision is made for the fixing device to extend at least partially over the placement device and/or beyond the placement device. As already mentioned above, the placement device is used in particular to introduce poultry animals into the transport device and/or to make it easier for, and/or to cause, a poultry animal to be positioned in the intended position on the transport rail.

A further preferred development is distinguished by the fact that the fixing elements have a greater spacing to one another, and/or a greater spacing to the transport axis, at their end in the region of the placement device than in the region of the transport rail. This can make it easier for the neck and/or head of a poultry animal to be introduced between the fixing elements.

In one preferred embodiment, provision is made for the fixing device to have a greater spacing to an upper edge of the placement device, and/or to the transport axis, in a middle portion of the placement device than at the two end portions of the placement device. This can make it easier for the poultry animal to be introduced in the intended position on the transport rail and/or for the scapulohumeral joint and/or the shoulder joint to be introduced into the respective receiving recesses of the driver device.

In one preferred embodiment, provision is made for the placement device to have, at its end adjacent to the transport rail, a width that is greater than a width at the opposite end of the placement device. Provision is preferably furthermore made for the placement device to taper, proceeding from its end adjacent to the transport rail, in a direction away from the transport rail. This makes it easier in particular for the poultry animals to be placed on by spreading the wings and/or legs open in a gradual manner.

A further preferred development is distinguished by the fact that the placement device has, at its end adjacent to the transport rail, a height that corresponds to the height of the transport rail, in particular the height of the guide elements. This makes it easier in particular for poultry animals to slide over from the placement device onto the transport rail.

A further preferred development is distinguished by the fact that the placement device has, at its end situated opposite the transport rail, a height that is greater than the height of the transport rail. Provision is preferably furthermore made for the placement device to be exchangeable. An adaptation to poultry animals with different characteristics, in particular with regard to body size and condition, is thus possible.

A further preferred development is distinguished by the fact that the drive is configured as a circulating drive. The drive may for example be configured as a chain drive and/or as a belt drive. The drive furthermore preferably runs substantially parallel to the transport axis. Provision is preferably furthermore made for the drive to be spaced apart from the transport rail in a horizontal direction orthogonal to the transport axis. The drive is preferably of unilateral configuration, that is to say in particular arranged substantially on one side of the transport device, in particular of the transport rail.

A further preferred development is distinguished by the fact that the drive changes its direction in the release portion. This advantageously causes the driver devices to move from the holding position into the release position. The drive is preferably configured to bring the driver device(s) into the holding position in the region of the placement device.

A further preferred refinement is characterized by a weighing device for weighing a poultry animal that has been placed onto the transport rail, wherein the weighing device is preferably arranged in a first functional portion and/or is preferably arranged at an underside of the transport rail and/or forms a part of the underside of the transport rail.

A further preferred development is distinguished by a first functional device, which is preferably arranged in the first functional portion, and/or a second functional device, which is preferably arranged in a second functional portion, and/or a third functional device, which is preferably arranged in a third functional portion, and/or one, two or more inspection devices, which are preferably arranged entirely or partially in the inspection portion and/or in the release portion and/or in one, two, or more of the functional portions. Further details and advantages of the functional and inspection devices will be described in more detail below.

Provision is preferably furthermore made for the transport device to comprise a provision device. The provision device preferably comprises substance container receptacles for one, two, or more substance containers. The provision device furthermore preferably comprises a conveying device, for example comprising one, two, or more pumps, for conveying the substance(s) to a location of use. The provision device furthermore preferably comprises a movement device for moving the substance containers. This is advantageous for preventing or reducing demixing of substance constituents. The provision device furthermore preferably comprises a temperature control device for controlling the temperature of substances. This is advantageous for keeping the substances in a desired temperature range. The substances may, for example, be vaccines. The provision device furthermore preferably comprises a ventilation device, in particular for removing or separating off gaseous constituents of the substances, such that the provided substances can preferably be conveyed without bubbles and/or can be administered without bubbles to a poultry animal.

In one preferred embodiment, provision is made for the first functional device to comprise a scratching element. The scratching element is preferably arranged on a guide element. The scratching element is furthermore preferably configured to make contact with and preferably scratch the skin, in particular in the region of the thigh, preferably an inner side of the thigh, of a poultry animal which has been placed onto the transport rail and which is driven along the transport rail by the driver device. It is preferred here in particular that the first functional device, in particular the scratching element, is fluidically connected to one, two or more of the substance containers, wherein a surface of the scratching element is preferably wetted with the substance.

In this way, one, two, or more substances can be administered to the poultry animal in an advantageous manner. The administration of a substance to a poultry animal as proposed here, in particular into the thigh thereof, preferably an inner side of the thigh, using a scratching element, has various advantages in relation to administering a substance into the wing webs. Administering by scratching the thigh is more reliable and less personnel-intensive, because, in the transport device described here, owing to the fact that the poultry animal is in an intended position on the transport rail, the scratching element can be positioned such that it inevitably scratches the thigh, in particular the inner side of the thigh. This is assisted in particular by the configuration of the inner and outer flanks of the guide elements. By virtue of the fact that the legs of the poultry animal project laterally beyond the guide elements, the thighs of the poultry animals also lie closely, and/or under slight pressure, against the guide elements, such that an arrangement of the scratching element in this region is preferred. It is particularly preferable for the first functional device, in particular the scratching element, to be used to administer a substance that is used for pox vaccination.

The first functional device may alternatively or additionally have a wing web vaccination device.

In one preferred embodiment, provision is made for the second functional device to comprise a spraying device. The second functional device is preferably configured to spray a substance in the direction of a poultry animal, preferably in the direction of the head of a poultry animal, in particular in the direction of the eyes of a poultry animal. The second functional device is furthermore preferably configured to detect the presence of a poultry animal and/or of a driver device at a particular position, for example in the second functional portion. This has the advantage that the emission of a pulsed spray of substance in the direction of the poultry animal can be activated, preferably by the control device, exactly when the poultry animal is situated at a position intended for this. The second functional device is thus preferably independent of a particular cycle rate, in particular from a time aspect. Rather, the spraying device can spray a substance exactly when the poultry animal is situated at the position intended for this. The particular position may be determined for example by means of a position sensor. Alternatively or in addition, the second functional device is configured to spray a substance in the direction of a poultry animal, preferably in the direction of the head of a poultry animal, in particular in the direction of the eyes of a poultry animal, in accordance with a cycle rate.

The second functional device is preferably fluidically connected to one, two or more of the substance containers.

In one preferred embodiment, provision is made for the third functional device to comprise a cam, which is preferably height-adjustable and/or movable along the transport axis and which is preferably configured to support the sternum, in particular the keel, of a poultry animal that has been placed onto the transport rail. In this way, the breast muscle of the poultry animal can be shaped into a crowned form, which is advantageous in particular for intramuscular administration of a substance. In particular, a stepped profile of the cam, or a profile of the cam which is continuous for example in certain portions, is advantageous here, such that the cam builds up the support of the sternum of the poultry animal gradually.

One advantageous refinement is distinguished by the fact that the third functional device comprises a needle arrangement which is preferably height-adjustable and/or movable along the transport axis. The needle arrangement comprises, in particular, at least two preferably movable needle administering means for in each case one, two or more needles. The needle administering means are preferably arranged symmetrically with respect to the transport axis. It is furthermore preferable for the needle administering means to be arranged at an angle of at least 15 degrees and/or at most 25 degrees with respect to the vertical and/or a vertical plane that encompasses the transport axis. It is furthermore preferred that the needle arrangement is fluidically connected to one, two, or more of the substance containers. The needle arrangement with the needle administering means serves in particular for intramuscular administration of one, two, or more substances into the breast muscle, which has been shaped into a crowned form, of the poultry animal. Here, it is preferred in particular that, in the third functional portion, the transport rail is configured as an open profile such that the breast region of the poultry animal is accessible to the cam and the needle arrangement.

A preferred refinement is distinguished by the fact that one, several, or all of the inspection devices comprise(s) a sensor, for example an ultrasonic sensor and/or a light barrier and/or a mechanical limit switch and/or a distance sensor. It is furthermore preferred that one, several, or all of the inspection devices comprise(s) a camera, in particular an imaging camera, a video camera, an infrared camera, and/or a camera combination for creating three-dimensional data. The inspection devices serve in particular for detecting, and preferably checking and/or storing and/or transmitting, information relating to characteristics and/or conditions of the poultry animals and/or the result of a handling operation that has been performed, for example the administration of a substance. For example, information relating to the condition of the plumage and/or of the crest and/or of the bill may be recorded and optionally evaluated. The transport device described here makes such inspections possible in an advantageous manner, because the poultry animals are situated in a defined and at the same time relaxed position, and a major part of the body of the poultry animal is accessible for an inspection, in particular if the transport rail is formed at least in certain portions as an open profile and is thus conducive to animal welfare.

Provision is preferably made for the weighing device and/or one, several, or all of the functional devices and/or one, several, or all of the inspection devices to be configured to transmit and/or to receive data, in particular to and/or from the control device.

It is furthermore preferable for the weighing device and/or one, several, or all of the functional devices and/or one, several, or all of the inspection devices to be connected to the control device and/or to one another in wired or wireless fashion.

In one preferred embodiment, provision is made for the transport device to be configured as a mobile transport device. This is to be understood in particular to mean that the transport device can be moved to a different location of use, in particular between different poultry houses and/or within one poultry house, easily and without extensive assembly and/or disassembly. Here, it is preferred in particular that the transport device has at least two rollers.

The transport device is furthermore preferably configured to be entirely or partially sterilizable. This is advantageous in particular when moving between different locations of use and/or during use for alternating poultry animal populations, in order to prevent a transmission of pathogens. The transport device is preferably configured to be cleaned using a liquid jet, in particular using a high-pressure cleaner.

The transport device preferably has a length of at most 2000 mm and/or a width of at most 600 mm and/or a height of at most 1500 mm. The transport rail furthermore preferably has a length of at most 1900 mm.

In a further embodiment, provision is made for one, several or all of the substances to be vaccines.

Further advantageous design variants of the transport device described above arise from different combinations of individual or several preferred features that have been described.

According to a further aspect, the object stated in the introduction is achieved by way of a method for automatically transporting living poultry animals in a transport direction, the method comprising: providing a transport device as described above, receiving a part of the poultry animal, in particular the torso and/or the breast and/or the breastbone and/or the sternum of the poultry animal, in the transport receptacle, preferably such that the poultry animal assumes, in particular, a position in which its thoracic spine, in particular the region between the shoulder joint and the hip joint, is oriented substantially horizontally, arranging the scapulohumeral joints and/or the shoulder joints of the poultry animal in the receiving recesses of the holding elements, and transporting the poultry animal by moving the driver device along the transport rail by means of the drive.

According to a further aspect, the object stated in the introduction is achieved by way of a method for commencing the operation of a transport device as described above, the method comprising: specifying poultry-animal-specific parameters, and adjusting at least one component of the transport device, in particular the guide elements and/or the holding elements and/or the fixing elements, in accordance with said parameters.

According to a further aspect, the object stated in the introduction is achieved by way of a method for automatically performing a handling operation on living poultry animals, preferably in a transport device, in particular in a transport device as described above, the method comprising: transporting, and preferably fixing, a poultry animal in a transport position in which, preferably, a thoracic spine of the poultry animal, in particular in the region between the shoulder joints and hip joints, is oriented substantially horizontally, and/or scratching the skin of a poultry animal, in particular on the thigh, preferably on an inner side of the thigh, wherein the scratching is preferably performed by a scratching device, wherein the scratching preferably takes place automatically by virtue of the poultry animal being transported across the scratching device and the scratching occurring as a result of the relative movement between the transported poultry animal and the positionally fixed scratching device, and/or administering a substance, in particular a vaccine, preferably a pox vaccine, into the thigh, and/or in particular an inner side of the thigh, preferably under the skin, of a poultry animal, and/or shaping the breast muscle of the poultry animal, in particular shaping the breast muscle of the poultry animal into a crowned form, in particular by supporting the sternum, in particular the keel, preferably by means of a cam, wherein the shaping into a crowned form preferably precedes an intramuscular administration of one or more substances into the breast muscle.

According to a further aspect, the object stated in the introduction is achieved through the use of a transport device as described above in a poultry house for the purposes of automatically transporting poultry animals in a transport direction and/or in one of the methods described above.

These further aspects, and their respective possible developments, have features and method steps that in particular render them suitable for use with an above-described transport device and the developments thereof. With regard to the advantages, design variants and design details of these further aspects of the invention and the developments thereof, reference is made to the above description relating to the corresponding features of the transport device.

With regard to the advantages, preferred embodiments and details of the individual aspects and the preferred embodiments thereof, reference is likewise made to the corresponding advantages, preferred embodiments and details that have been described with reference to the respective other aspects.

Further advantageous embodiments arise from the combination of individual, several, or all preferred features that are described here.

### BRIEF DESCRIPTION OF THE DRAWINGS

Preferred exemplary embodiments will be described by way of example on the basis of the appended figures, in which:

FIG. 1 shows a three-dimensional view of an exemplary embodiment of a mobile transport device;

FIG. 2 shows a further three-dimensional view of the transport device as per FIG. 1 obliquely from below;

FIG. 3 shows a three-dimensional view of the transport rail with the fixing device of the transport device as per FIG. 1;

FIG. 4 shows a three-dimensional view of the placement portion of the transport device as per FIG. 1, with a poultry animal;

FIG. 5 shows a three-dimensional view of the release portion of the transport device as per FIG. 1, with a poultry animal;

FIG. 6 shows a further three-dimensional view of the release portion of the transport device as per FIG. 1, with two poultry animals;

FIG. 7 shows a three-dimensional view of the transport rail and of a driver device of the transport device as per FIG. 1 in the region of the placement portion, with a poultry animal;

FIG. 8 shows a three-dimensional view of a detail of the transport device as per FIG. 1 in the region of the placement portion;

FIG. 9 shows a three-dimensional view of the placement portion as per FIG. 1;

FIG. 10 shows a three-dimensional view of a driver device of the transport device as per FIG. 1, with a part of the drive;

FIGS. 11A, 11B, 11C, and 11D show side views of different positions of the lowering movement of the driver device of the transport device as per FIG. 1 at the release portion;

FIG. 12 shows a three-dimensional view of the transport rail of the transport device as per FIG. 1;

FIG. 13 shows the transport rail as per FIG. 12 in side view;

FIG. 14 shows the transport rail as per FIG. 12 in the section A-A as per FIG. 13;

FIG. 15 shows the transport rail as per FIG. 12 in the section B-B as per FIG. 13;

FIG. 16 shows a three-dimensional view of the transport rail, the fixing device, a driver device, and a needle arrangement of the transport device as per FIG. 1;

FIG. 17 shows a three-dimensional view of the needle arrangement of the transport device as per FIG. 1;

FIG. 18 shows a three-dimensional view of the cam of the transport device as per FIG. 1;

FIG. 19 shows a schematic flow diagram of an exemplary embodiment of a method for automatically transporting living poultry animals in a transport direction;

FIG. 20 is a schematic illustration of an exemplary embodiment of a method for commencing the operation of a transport device; and

FIG. 21 is a schematic illustration of an exemplary embodiment of a method for automatically performing a handling operation.

### DETAILED DESCRIPTION OF THE EMBODIMENTS

In the Figures, identical or substantially functionally identical elements are denoted by the same reference designations. As a rule, general descriptions relate to all embodiments unless differences are explicitly specified.

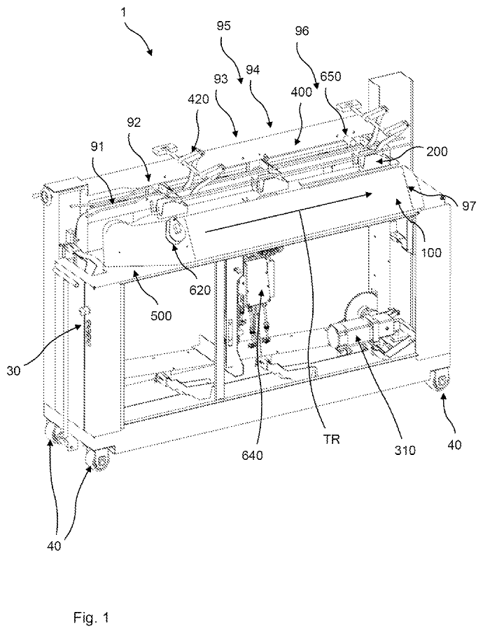

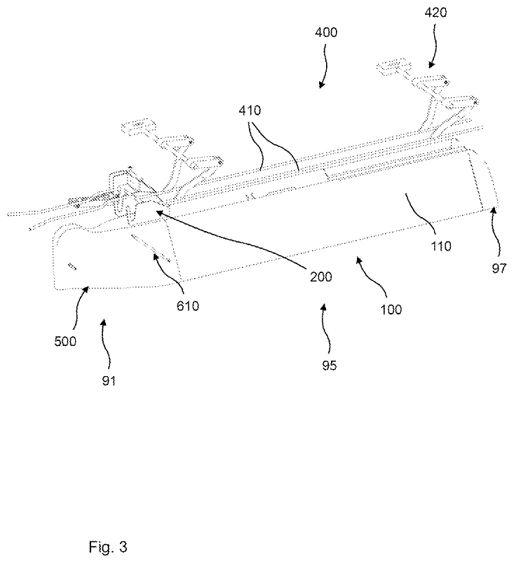

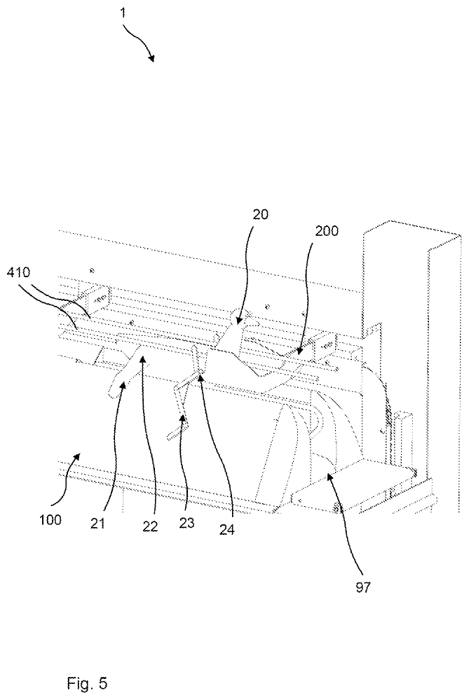

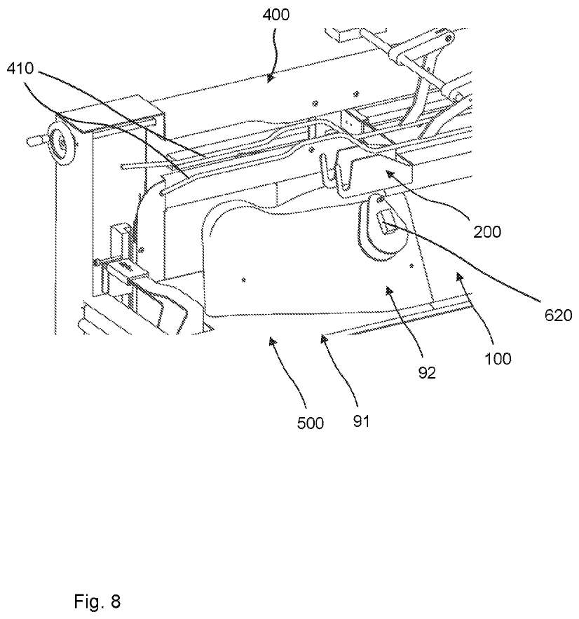

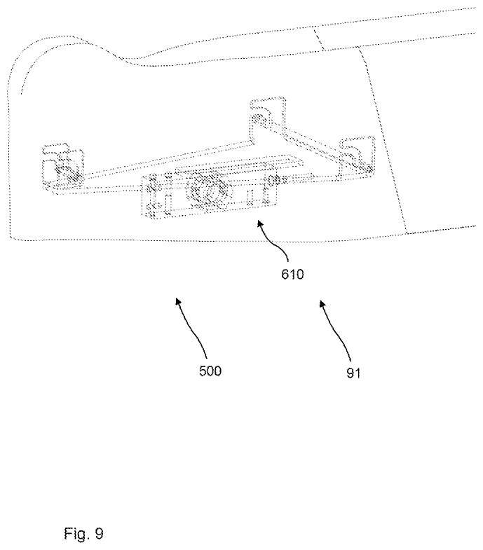

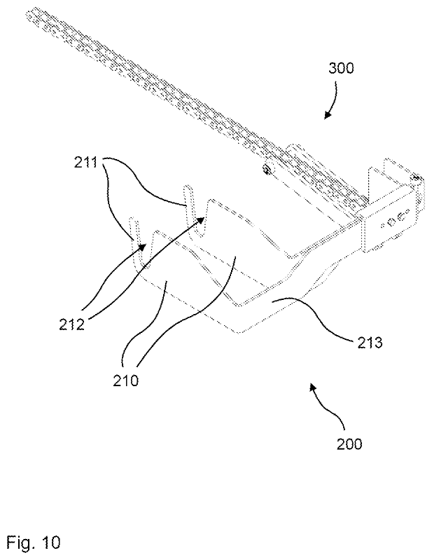

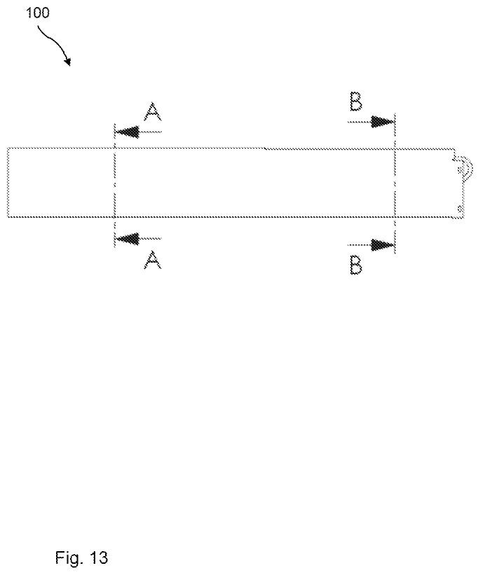

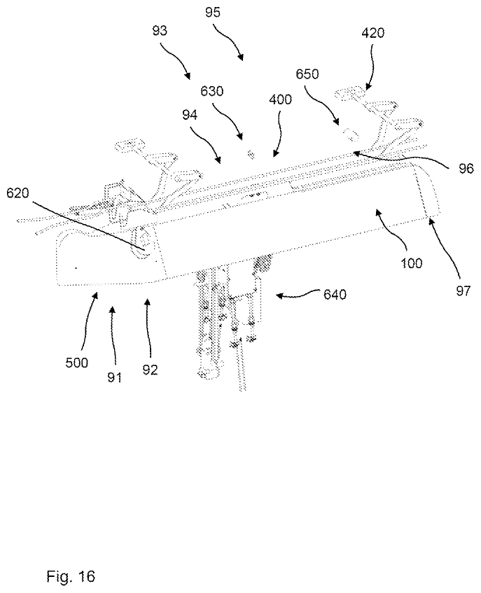

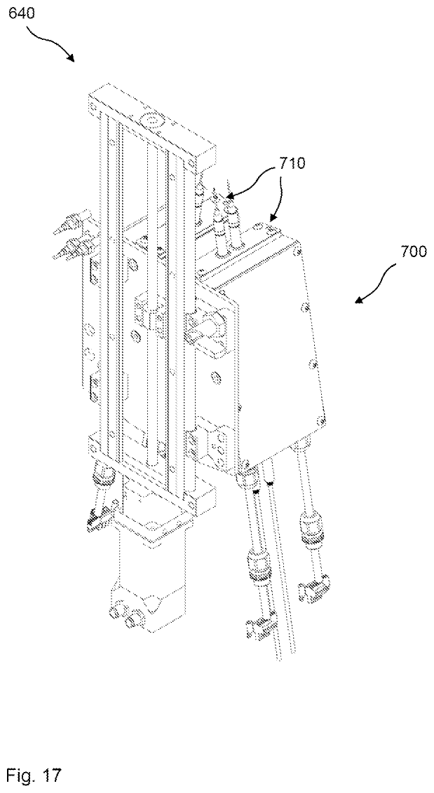

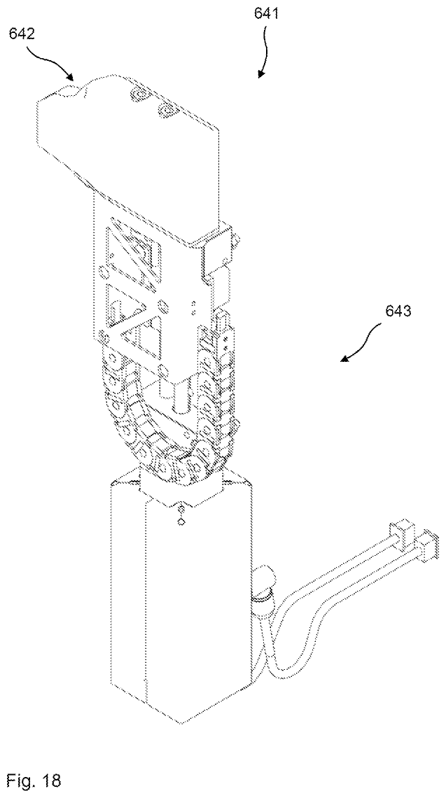

FIGS. 1 to 18 illustrate an exemplary embodiment of a transport device 1, and various details thereof.

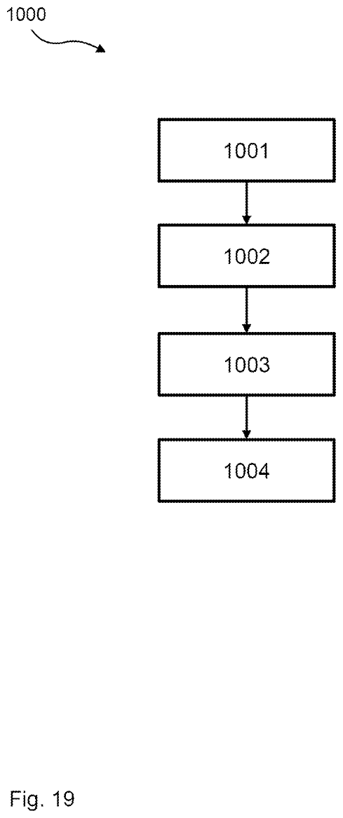

The specifics and details, described below, of the transport device 1 illustrated in the Figures may advantageously be used in combination with one another. The described features, specifics and details are each also advantageous on their own or in combination with in each case only one, two or several of the other features, such that advantageous transport devices are realized even if individual or several specifics that are shown here are omitted. The same applies correspondingly to the method sequences illustrated by way of example in FIGS. 19 to 21. In particular, these method sequences may be supplemented by corresponding further method steps that are expedient, necessary or advantageous in the use of the described transport device.

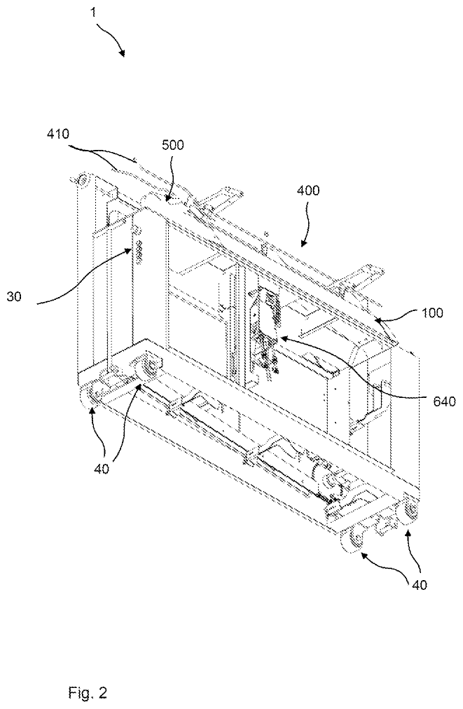

As can be seen in particular in FIGS. 1 and 2, the transport device 1 illustrated here is configured as a mobile transport device 1. This can be seen in particular from the compact structural form and the rollers 40. In this way, the transport device 1 can, for example within a poultry house, be moved easily between different locations of use, for example different poultry animal pens of one house. A mobile transport device 1 can likewise advantageously be used in different poultry houses, and thus moved between these. This is possible directly, for example by way of the rollers 40 of the transport device 1, if the poultry houses are situated in close proximity. The transport device 1 can likewise be transported to further remote poultry houses, for example on the load floor of a transport vehicle that is provided or suitable for this purpose.

Here, it is preferable in particular for the transport device 1 to be configured to be sterilizable and/or such that it can be cleaned using a liquid jet, in particular using a high-pressure cleaner, for example in order to prevent pathogens from being transmitted from one poultry animal population to another.

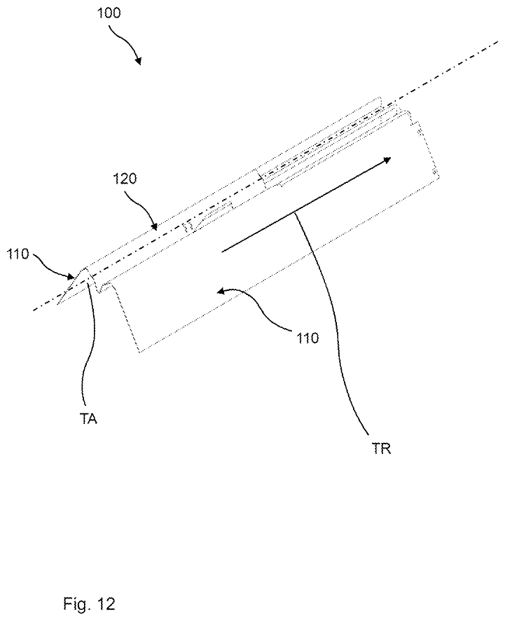

The transport device 1 illustrated here serves for automatically transporting living poultry animals 20 in a transport direction TR that runs parallel to the transport axis TA. As can be seen in particular in FIGS. 12, 14, and 15, the transport axis TA is located, as an imaginary line, centrally between the upper ends of the guide elements 110 of the transport rail 100. In the example illustrated here, the transport axis TA runs along a straight line. The transport axis TA may however likewise have changes in direction and/or bands, for example upward, downward, to the right, and/or to the left, and any combinations thereof. The transport axis TA preferably corresponds to the movement path on which the poultry animals 20 are transported the transport direction TR in the transport device 1.

The transport device 1 has various portions which, in the example described here, aside from the placement portion 91 at the start and the release portion 97 at the end, include a weighing portion, three functional portions 92, 93, 94, a fixing portion 95, and an inspection portion 96. In the functional portions 92, 93, 94, it is possible in particular for handling operations, for example the administration of substances, in particular vaccines, to be performed on the poultry animals, as will be described in more detail below. In the example shown here, the fixing portion 95 extends over the entire length of the transport rail 100, because the poultry animals 20 are fixed by means of the fixing device 400 over the entire length of the transport rail 100. These portions will be described in more detail below.

The poultry animals 20 are transported in the transport device 1 in particular in the manner described below.

The poultry animals 20 are placed onto the placement device 500 in the region of the placement portion 91. This may for example be performed manually by personnel. When the poultry animals 20 are placed onto the placement device 500, the head and/or neck of the poultry animals is introduced between the fixing elements 410 of the fixing device 400, which are spread apart at this end. Furthermore, the legs 21 and wings 23 of the poultry animal 20 are positioned laterally outside the placement device 500. The placement device 500 is configured to be relatively narrow at that end of the placement device 500 which is averted from the transport rail 100, such that the poultry animals 20 are placed on, and the legs 21 and wings 23 are spread apart, easily and gently.

Furthermore, in the placement portion 91, the shoulder joints 24 of the poultry animals 20 are mounted into the receiving recesses 212 of the holding elements 210 of the driver devices 200. The driver portions 211 of the holding elements 210 of the driver device 200 thus engage behind the shoulder joints 24 of the poultry animals 20. The shoulder joint 24 can also be referred to as scapulohumeral joint. In order to make this mounting of the shoulder joints 24 of the poultry animals 20 into the receiving recesses 212 of the driver device 200 in the placement portion 91 easier, the fixing elements 410 are deflected upward in this region in order to create the corresponding free movement space here for the mounting operation. In the fixing portion 95 that adjoins the placement portion 91, the fixing elements 410 then have a smaller spacing to the transport axis TA, such that the freedom of movement of the poultry animal 20 in an upward direction is restricted by the fixing elements 410.

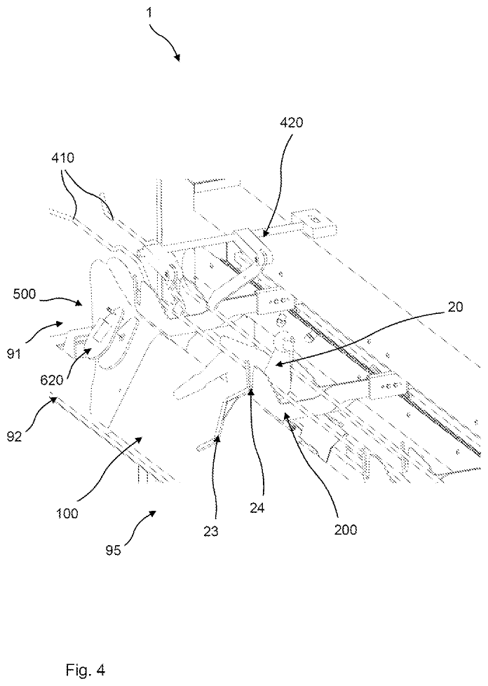

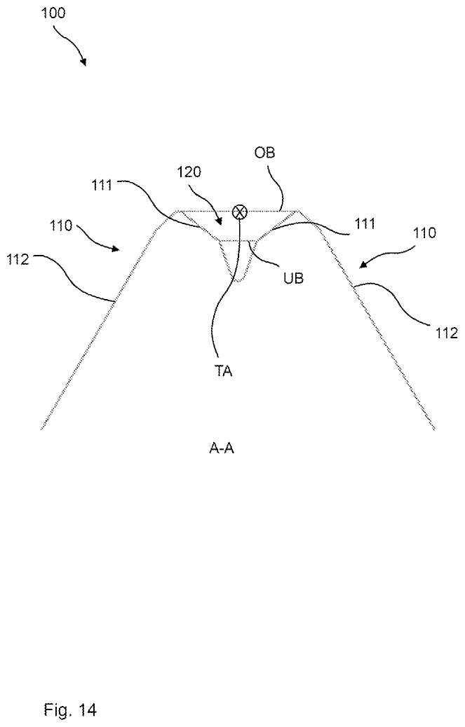

The placement device 500 widens toward the transport rail 100, such that the torso and/or the breastbone and/or the sternum of the poultry animal 20 comes to lie in the transport receptacle 120, which is situated between the guide elements 110 of the transport rail 100. The torso and/or the breastbone and/or the sternum of the poultry animal 20 is in this case guided and/or held between the two guide elements 110 in the transport receptacle 120. As can be seen in particular in FIG. 14, the transport receptacle 120 narrows toward its lower end, in the example shown here from an upper width OB to a lower width UB, and then once again from said lower width UB to the lower end of the transport receptacle. The transport receptacle 120 is delimited by the inner flanks 111 of the guide elements 110. The legs 21 and wings 23 of the poultry animals 20 project laterally beyond the guide elements 110 and lie against the upper region of the outer flanks 112 of the guide elements 110, as is schematically indicated in particular in FIGS. 4, 5, and 6.

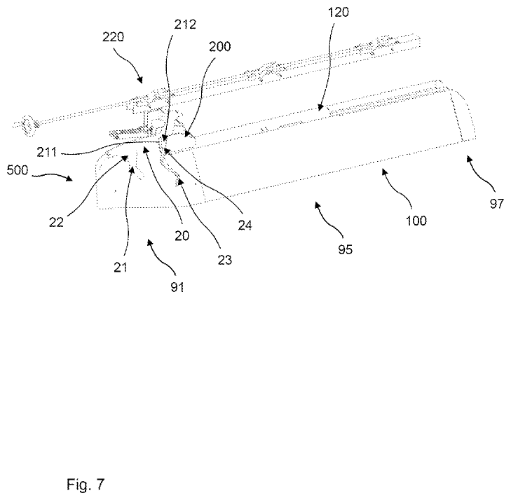

FIG. 7 shows the position of the poultry animal 20, which has been mounted with its shoulder joints 24 into the receiving recesses 212 of the driver device 200, in the placement portion 91. After the poultry animal 20 has been placed onto the placement device 500, the shoulder joints 24 have been mounted into the receiving recesses 212 of the driver device 200, and the neck and/or head has been introduced between the fixing elements 410, the poultry animal 20 is situated in the intended transport position. Here, the thoracic spine of the poultry animal 20, in particular in the region between the shoulder joints 24 and the hip joints 22, is oriented substantially horizontally, as can be seen in particular in FIGS. 4, 5, 6, and 7. At the same time, the head of the poultry animal 20 is oriented upward and can be moved, for example turned slightly, because the fixing device 400 primarily prevents a lateral movement and/or an upward movement of the poultry animal 20. This intended transport position of the poultry animal 20 is a relatively relaxed and natural posture for the poultry animal 20, which has the advantage that it leads to little stress and thus also little agitation in the poultry animals, and to a low risk of injury. Transport which is particularly gentle on the animals, and which is at the same time efficient, is thus possible.

The position assumed by the poultry animals 20 in the transport device 1 also has the advantage of allowing improved and/or easier manipulation, and/or of allowing handling operations on poultry animals 20 to be performed in an improved manner and/or more easily, as will be described in more detail below.

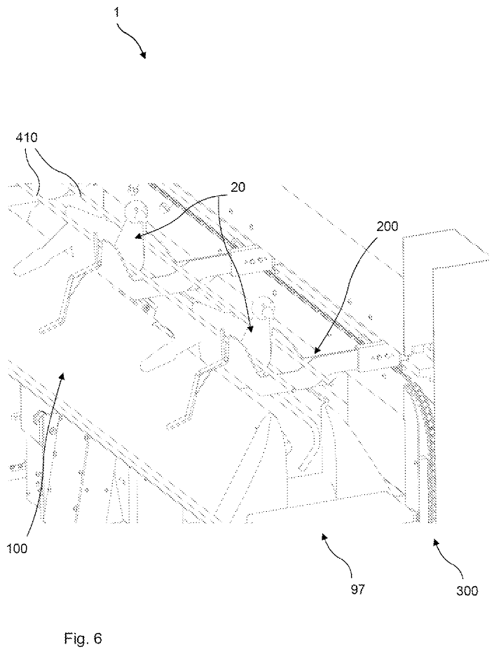

The movement of the poultry animals 20 along the transport axis TA in the transport direction TR is effected by movement of the driver devices 200. As can be seen in particular from FIGS. 1, 4, and 6, the transport device 1 has multiple driver devices 200, which are spaced apart from one another. The spacing between the driver devices 200 is in particular dimensioned such that a poultry animal can easily fit between two adjacent driver devices 200, as can be seen in particular in FIGS. 4 and 6.

The driver devices 200 are likewise moved in the transport direction, and along or parallel and/to the transport axis TA, by the drive 300, which is configured here as a circulating drive in the form of a unilateral chain drive with an electric motor 310. Since the shoulder joints 24 of the poultry animals 20 have been mounted into the receiving recesses 212 of the holding elements 210 of the driver devices 200, the poultry animals 20 are likewise concomitantly moved forward, by means of the driver portions 211, during a forward movement of the driver devices 200. Owing to their plumage, the poultry animals 20 exhibit low friction, and can easily slide along the transport rail 100.

A first functional portion 92 is situated in the region of the placement device 500 in the placement portion 91. This first functional portion comprises a weighing device 610, by means of which the weight of the poultry animal can be ascertained. Since the fixing device 400 does not make contact, or makes only light contact, with the poultry animal in its intended position, an undistorted weight of the poultry animal can be ascertained. Also arranged in the first functional portion 92 is a first functional device 620, which is illustrated in FIGS. 1, 4, 8, and 16 in the form of wing web vaccination devices. A scratching element (not illustrated) is however preferably provided as a first functional device 620, which scratching element is preferably arranged on a guide element 110 such that it can make contact with and scratch the skin, in particular in the region of the thigh, preferably on an inner side of the thigh, of a poultry animal 20 which has been placed onto the transport rail 100 and which is being driven along the transport rail 100 by the driver device 200. Since the scratching element is preferably fluidically connected to one, two, or more substance containers, and a surface of the scratching element is preferably wetted with substance, a substance can be administered to the poultry animal 20 in this way. The substance is particularly preferably a vaccine, in particular a pox vaccine.

This means of administering a substance to the inner side of the thigh of the poultry animals 20 is a particular advantage of the transport device described here. In relation to a wing web vaccination device, the administration of a substance to the inner side of the thigh of the poultry animal 20 using a scratching element has the advantage that it can take place automatically as the poultry animal 20 slides along the transport rail 100, without manual intervention by personnel being necessary for this purpose. By contrast, in the case of the wing web vaccination device, the wings must be spread apart manually and the wing web vaccination device applied, which is a cumbersome and error-prone process.

In the example illustrated here, a second functional portion 93 and a third functional portion 94 are also provided, which overlap one another and are also provided within the fixing portion 95. An inspection portion 96 is also provided, which is likewise configured to overlap the second and third functional portions 93, 94 and which is likewise arranged in the fixing portion 95. The various portions may however also be arranged in some other way, in particular in accordance with which functions are required and preferred in the respective portions.

Arranged in the second functional portion 93 is a second functional device 630, which in the present example is configured as a spraying device that can spray a substance from a substance container, which is fluidically connected to the spring device, in the direction of the poultry animal, in particular of the head and/or of the eyes of the poultry animal, whereby it is possible in particular to perform a spray vaccination.

Arranged in the third functional portion 94 is a third functional device 640 which is configured here as a needle arrangement 700, which is preceded by a cam 641. The third functional device 640 is preferably arranged so as to access the torso and/or the breast and/or the breastbone and/or the sternum of the poultry animal, in particular its breast muscle, from below.

The cam 641 is configured to support the sternum, in particular the keel, of a poultry animal 20 such that the breast muscle of the poultry animal 20 is shaped into a crowned form. This is preferred for the purposes of intramuscular injection of a substance into the breast muscle using the downstream needle arrangement 700 and the two needle administering means 710, which in this case each comprise two needles. In this case, too, the substance is preferably a vaccine.

For this purpose, the cam 641 has, in particular, a stepped profile 642 in order to support the sternum, in particular the breastbone, in a gradual manner that is pleasant for the poultry animal 20. Furthermore, the cam 641 is preferably configured to be movable by means of the cam drive 643, for example in a direction parallel to the transport axis TA and/or orthogonally with respect thereto.

The cam 643 described here has the advantage in particular that the breast muscle is shaped into a crowned form prior to the injection by the needles of the needle administering means 710. When injecting vaccines into the breast muscle, it is preferred to use several different needles, because the vaccines are not necessarily compatible with one another and it is therefore preferred for said vaccines to be introduced at spatially separate locations. Furthermore, for reliable intramuscular vaccination, an exact penetration depth of the needles must be ensured. However, erroneous administration of vaccinations can often occur here when using existing methods, because the breast muscle in poultry animals 20, in particular in laying hens, is not particularly pronounced. By virtue of the breast muscle being shaped into a crowned form by means of the cam 643 prior to the injection using the needle arrangement 700, much more reliable vaccination can be ensured.

One or more inspection devices 650, for example in the form of sensors or cameras, are provided in the inspection portion 96. These can be used to record and document various characteristics and/or conditions of the poultry animals 20. Furthermore, the inspection device is 650 can preferably also be used to record and document the results of the handling operations performed, such as vaccinations.

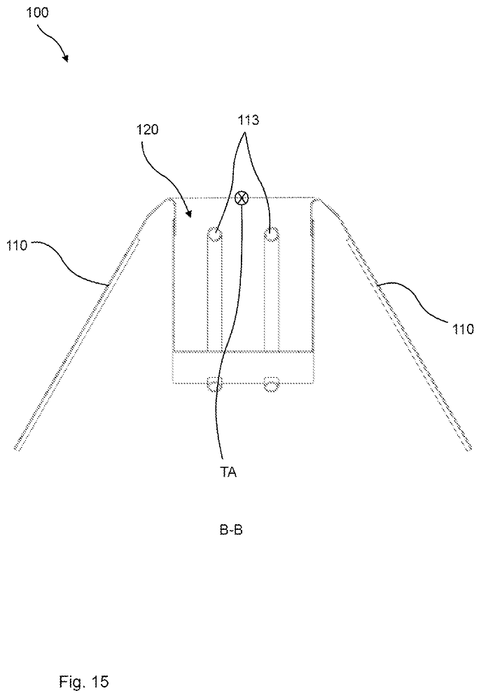

In order to make the underside of the torso of the poultry animal 20 accessible for such inspections and/or handling operations, in particular the administration of substances, the transport rail 100 is configured as an open profile in certain portions, as can be seen in particular in FIG. 12. In FIG. 12, in the rear part of the transport rail 100 as viewed in the transport direction TR, it can be seen that the inner flanks 111 of the guide elements 110 of the front part of the transport rail 100 in the transport direction TR are replaced here by guide rails 113. This can also be clearly seen once again in FIG. 15, which illustrates a section through this part of the transport rail 100. The guide rods 113 support the torso of the poultry animal 20, such that, in this region of the transport rail 100, too, the poultry animal 20 is securely held in the transport receptacle 120 and positioned in the intended transport position. At the same time, the open profile of the transport rail 120 in this region also allows manipulation of, administration of a substance to, and/or inspection of, the lower region of the torso of the poultry animal 20.

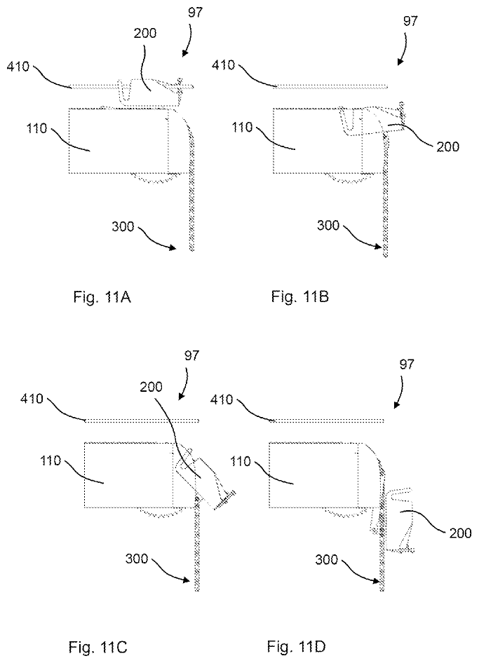

Situated at the end of the transport device 1 is a release portion 97, in which the poultry animals 20 are discharged from the transport device 1 again. In this release portion 97, the drive 300 of the driver devices 200 is configured such that the holding elements 210, in particular the driver portions 211 and the receiving recesses 212, are lowered downward such that their upper ends move below the upper ends of the guide elements 110 of the transport rail 100. The driver devices 200 therefore move from the holding position into the release position in the release portion 97. For this purpose, the drive 300 preferably changes its drive direction in the release portion 97. The driver devices assume the holding position in the placement portion 91, and preferably maintain this holding position in the further portions 92, 93, 94, 95, 96 as far as the portion 97. The driver device 200, in particular the holding elements 210, in particular the respective receiving recess 212 and/or the respective driver portion 211, is or are, in the holding position, arranged above the transport rail 100, in particular above the upper ends of the guide elements 110. The driver device 200, in particular the holding elements 210, is or are, in the release position, arranged at least in certain portions below the transport rail 100, in particular below the upper ends of the guide elements 110. The lowering of the driver devices 200, in particular of the receiving recesses 212 and of the driver portions 211, downward so as to move below the fixing elements 410 of the fixing device 400 and below the upper ends of the guide elements 110 of the transport rail 100 is illustrated in detail in particular in FIGS. 11A to 11D.

In this way, the shoulder joints 24 are released from the receiving recesses 212 and can no longer be driven along by the driver portions 111 of the holding elements 110. Therefore, at the end of the release portion 97, the poultry animal 20 can leave the end of the transport rail 100 and of the fixing device 400, optionally with manual assistance.

The driver devices 200 furthermore have a front pushing piece 213. If necessary, a poultry animal 20 which is positioned in front of the front pushing piece 213 in the transport direction TR, and which is already situated in the release portion 97 and is no longer being driven along by the driver portions 211 of the driver device 200 situated in front, can be pushed ahead by the front pushing piece 213, which can thus assist the process of the poultry animal 20 leaving the transport device 1.

The transport device 1 is furthermore preferably configured to be adapted to different types of poultry animals for transport. It is accordingly preferable for the fixing elements 410 of the fixing device 400 to be adjustable in terms of their horizontal spacing to one another, and/or in terms of their vertical spacing to the transport axis TA, by means of the fixing element adjusting device 420. The holding elements 210 of the driver devices 200 are preferably also adjustable in terms of their horizontal spacing to one another, and/or in terms of their vertical spacing to the transport axis TA, by means of the holding element adjusting device 220. The placement device 500 and/or the transport rail 100 may preferably be configured to be exchangeable. It is furthermore preferable for the guide elements 110 of the transport rail 100 to be adjustable in terms of their horizontal spacing to one another and/or in terms of their vertical spacing to the transport axis TA.

It is furthermore preferred that parameters relating to the handling operations to be performed, such as vaccinations, for example the type and quantity of the (vaccination) substances that are to be administered, can also be specified in a manner dependent on the type of poultry animal. The possible adjustments of the various components of the transport device 1 can preferably be performed by means of a control device 30.

The device described here and in particular be operated and/or used and/or set in operation using the following methods. The steps described may preferably be performed in the stated sequence. Individual, several or all steps may however also be performed in some other sequence if this is expedient or preferred in the situation of use.

FIG. 19 schematically illustrates a method 1000 for automatically transporting living poultry animals 20 in a transport direction TR. In step 1001, a transport device described here is firstly provided. In step 1002, a part of the poultry animal 20, in particular the torso and/or the breast and/or the breastbone and/or the sternum of the poultry animal 20, is received in the transport receptacle 120, and in step 1003, the scapulohumeral joints and/or the shoulder joints 24 of the poultry animal 20 are arranged in the receiving recesses 212 of the holding elements 210. In step 1004, the poultry animal 20 is transported along the transport rail 100 by virtue of the driver device 200 being moved by means of the drive 300.

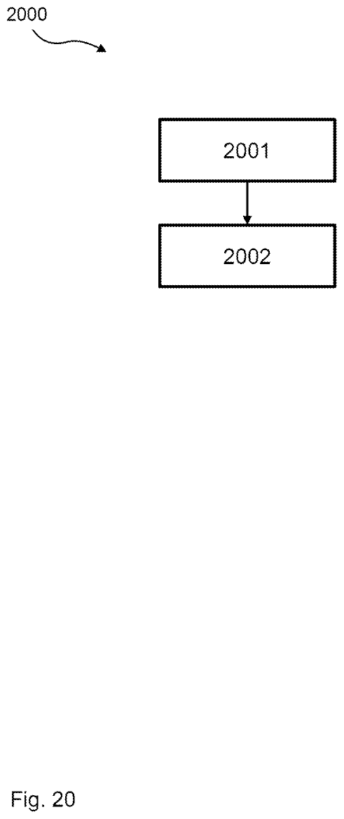

The method 2000 shown in FIG. 20 for commencing the operation of a transport device 1 described here comprises, in a step 2001, specifying poultry-animal-specific parameters and, in a step 2002, adjusting at least one component of the transport device in accordance with said parameters.

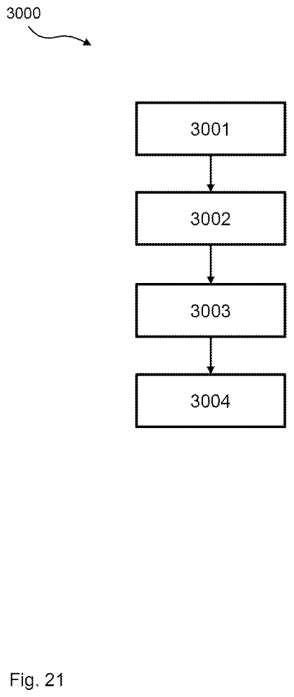

Furthermore, FIG. 21 illustrates a method 3000 for automatically performing a handling operation on living poultry animals, preferably in a transport device, in particular in a transport device 1 described above.

The method 300 comprises, in a step 3001, transporting, and preferably fixing, a poultry animal 20 in a transport position in which, preferably, a thoracic spine of the poultry animal 20, in particular in the region between the shoulder joints 24 and hip joints 22, is oriented substantially horizontally.

Alternatively or in addition, the method 3000 comprises, in step 3002, scratching the skin of a poultry animal 20, in particular on the thigh, preferably on an inner side of the thigh. The scratching is preferably performed by a scratching device. The scratching furthermore preferably takes place automatically by virtue of the poultry animal 20 being transported across the scratching device and the scratching occurring as a result of the relative movement between the transported poultry animal 20 and the positionally fixed scratching device.

Alternatively or in addition, the method 3000 comprises, in step 3003, administering a substance, in particular a vaccine, preferably a pox vaccine, into the thigh, and/or in particular an inner side of the thigh, preferably under the skin, of a poultry animal.

Alternatively or in addition, the method 3000 comprises, in step 3004, shaping the breast muscle of the poultry animal 20, in particular shaping the breast muscle of the poultry animal 20 into a crowned form, in particular by supporting the sternum, in particular the keel, preferably by means of a cam 641, wherein the shaping into a crowned form preferably precedes an intramuscular administration of one or more substances into the breast muscle.

The use of a transport device 1 in a poultry house for automatically transporting poultry animals 20 in a transport direction TR is also preferred. The use of a transport device 1 in one of the methods described here is likewise preferred.

1.-15. canceled.

16. A transport device for automatically transporting living poultry animals in a transport direction, the transport device comprising:
a transport rail extending along a transport axis, the transport rail further comprising two guide elements and a transport receptacle formed between the guide elements;
at least one driver device which has two holding elements, wherein each holding element has a driver portion and a receiving recess; and
a drive adapted to move the at least one driver device along the transport rail.

17. The transport device as claimed in claim 16, comprising:
a fixing device;
a placement device positioned upstream of the transport rail in a transport direction and which transitions into the transport rail, and
multiple driver devices;
wherein the driver devices are of identical form, and the driver devices are spaced apart from one another between 180 mm and 650 mm in a transport direction.

18. The transport device as claimed in claim 16, wherein the transport device has two or more portions and the portions are selected from the group consisting of:
a placement portion;
a functional portion;
a fixing portion;
an inspection portion; or
a release portion.

19. The transport device as claimed in claim 16, wherein the transport rail:
has, in a plane orthogonal to the transport axis, a cross section with a substantially M-shaped profile;
is configured entirely or partially at least in certain portions as a closed profile;
is configured entirely or partially at least in certain portions as an open profile;
is configured such that the thoracic spine of a poultry animal that has been placed onto the transport rail is oriented substantially parallel to the transport axis and/or transport direction;
is configured such that a torso, breast, breastbone, or sternum of a poultry animal that has been placed onto the transport rail is or are arranged in the transport receptacle;
is configured such that a hip joint, shoulder joints, or scapulohumeral joint of a poultry animal that has been placed onto the transport rail are arranged at an upper end of the transport rail or project above the transport rail; or
is configured such that a wing or leg of a poultry animal that has been placed onto the transport rail project outward beyond the guide elements.

20. The transport device as claimed claim 16, wherein:
the guide elements are configured as guide rods or as support webs;
the guide elements each have the same spacing to the transport axis or to a vertical plane that encompasses the transport axis;
the transport receptacle has, in a plane orthogonal to the transport axis, a cross section with a V-shaped profile or a U-shaped profile; or
the transport receptacle is configured to receive a part of the poultry animal, including a torso, breast, breastbone, sternum of the poultry animal.

21. The transport device as claimed in claim 16, wherein:
the receiving recess of the holding elements is configured to receive a scapulohumeral joint or a shoulder joint of a poultry animal;
the driver portion of the holding elements is configured to drive the scapulohumeral joint or the shoulder joint, which is arranged in the receiving recess, of the poultry animal in the transport direction;
the driver device has a holding position and a release position, wherein the driver device is pivotable from the holding position into the release position and vice versa about a pivot axis that is arranged horizontally or orthogonally with respect to the transport axis or with respect to the transport direction;
the driver device is secured against pivoting about an axis that is parallel to the transport axis;
the driver device is, in a holding position, arranged above the transport rail;
the driver device is, in the release position, arranged at least in certain portions below the upper ends of the guide elements;
the spacing of the holding elements substantially corresponds to the spacing between the scapulohumeral joints or the shoulder joints of the poultry animal; or
a spacing of the holding elements to the transport axis or to a vertical plane that encompasses the transport axis substantially corresponds to the spacing of the guide elements, to the transport axis or to a vertical plane that encompasses the transport axis.

22. The transport device as claimed in claim 17, wherein:
the fixing device has two fixing elements;
the fixing device is arranged above the transport rail, above the lower ends of the respective receiving recesses, or parallel to the transport axis;
the spacing of the fixing elements substantially corresponds to, or is greater than, the width of a neck, the head, or torso of a poultry animal;
a spacing of the fixing elements to the transport axis or to a vertical plane that encompasses the transport axis is adjustable;
a spacing of the fixing elements to the transport rail or to the transport axis is adjustable;
the fixing device extends across one, two, several or all portions of the transport device;
the fixing device ends, in a release portion, between 20 mm and 80 mm before the end of the transport rail or the end of the guide elements; or
the fixing device extends at least partially over the placement device or beyond the placement device.

23. The transport device as claimed claim 17, wherein:
the placement device has, at its end adjacent to the transport rail, a width that is greater than a width at the opposite end of the placement device;
the placement device tapers, proceeding from its end adjacent to the transport rail, in a direction away from the transport rail;
the placement device has, at its end adjacent to the transport rail, a width that is greater than a width at the opposite end of the placement device;
the placement device has, at its end situated opposite the transport rail, a height that is greater than the height of the transport rail;
the drive is configured as a circulating drive;
the drive is configured as a chain drive or as a belt drive; or
the drive changes its drive direction in the release portion.

24. The transport device as claimed in claim 16, comprising:
a weighing device for weighing a poultry animal that has been placed onto the transport rail, wherein the weighing device is arranged in a first functional portion or is arranged at an underside of the transport rail or forms a part of the underside of the transport rail;
a first functional device arranged in the first functional portion;
a second functional device arranged in a second functional portion;
a third functional device arranged in a third functional portion;
one or more inspection devices arranged entirely or partially in an inspection portion, in a release portion, or in one or more of the functional portions; or
a provision device, wherein the provision device preferably comprises substance container receptacles for one or more substances;
a conveying device for conveying the substances to a location of use;
a movement device for moving the substance containers;
a temperature control device for controlling the temperature of substances; or
a ventilation device for removing or separating off gaseous constituents of the substances.

25. The transport device as claimed in claim 24, wherein the first functional device comprises a scratching element arranged on a guide element or configured to make contact with and scratch a skin portion of a thigh of a poultry animal which has been placed onto the transport rail and which is driven along the transport rail by the driver device;
wherein the scratching element is fluidically connected to one or more of the substance containers, wherein a surface of the scratching element is preferably wetted with the substance;
wherein the second functional device comprises a spraying device;
wherein the third functional device comprises a cam which is height-adjustable or movable along the transport axis and which is configured to support a sternum of a poultry animal that has been placed onto the transport rail;
wherein the third functional device comprises a needle arrangement which is height-adjustable or movable along the transport axis and which comprises at least two needles arranged symmetrically with respect to the transport axis or at an angle between 15 degrees and 25 degrees with respect to the vertical or a vertical plane that encompasses the transport axis; or
wherein the needle arrangement is fluidically connected to one or more of the substance containers.

26. The transport device as claimed in claim 24, wherein:
a one of the inspection devices comprises a sensor;
a one of the inspection devices comprises a camera;
the transport device is configured as a mobile transport device; or
a one of the substances are vaccines.

27. A method for automatically transporting living poultry animals in a transport direction, wherein the method comprising:
providing a transport device comprising a transport rail extending along a transport axis, the transport rail further comprising two guide elements and a transport receptacle formed between the guide elements, at least one driver device which has two holding elements, wherein each holding element has a driver portion and a receiving recess, and a drive adapted to move the at least one driver device along the transport rail;
receiving a part of a poultry animal in the transport receptacle;
arranging a scapulohumeral joint or a shoulder joint of the poultry animal in the receiving recesses of the holding elements; and
transporting the poultry animal by moving the driver device along the transport rail by means of the drive.

28. A method for commencing the operation of a transport device as claimed in claim 27, the method comprising:
specifying poultry-animal-specific parameters; and
adjusting at least one component of the transport device in accordance with the parameters.

29. A method for automatically performing a handling operation on living poultry animals in a transport device as claimed in claim 16, the method comprising:
transporting and fixing a poultry animal in a transport position in which a thoracic spine of the poultry animal is oriented substantially horizontally;
scratching the skin of the poultry animal on an inner side of the thigh, wherein the scratching is performed by a scratching device;
administering a vaccine into the inner side of the thigh under the skin of the poultry animal; and
shaping the breast muscle of the poultry animal by supporting the sternum by means of a cam, wherein the shaping into a crowned form precedes an intramuscular administration of one or more substances into the breast muscle.

30. The use of a transport device as claimed in claim 16 in a poultry house for the purpose of automatically transporting poultry animals in a transport direction.

31. The use of a transport device in a poultry house for the purpose of automatically transporting poultry animals in a transport direction and according to the method of claim 27.

32. A transport device for automatically transporting living poultry animals in a transport direction, the transport device comprising:
a transport rail extending along a transport axis, the transport rail further comprising two guide elements and a transport receptacle formed between the guide elements;
at least one driver device which has two holding elements, wherein each holding element has a driver portion and a receiving recess, wherein the receiving recess of the holding elements is configured to receive a scapulohumeral joint or a shoulder joint of a poultry animal and the driver portion of the holding elements is configured to drive the scapulohumeral joint or the shoulder joint, which is arranged in the receiving recess, of the poultry animal in the transport direction; and
a drive adapted to move the at least one driver device along the transport rail.

33. The transport device as claimed in claim 32, wherein the transport device comprises:
a placement portion; and
a release portion.

34. The transport device as claimed in claim 33, wherein the placement portion comprises a placement device having, at its end adjacent to the transport rail, a width that is greater than a width at the opposite end of the placement device.

35. The transport device as claimed in claim 33, wherein the release portion is between 20 mm and 80 mm before the end of the transport rail or the end of the guide elements.
